(19) United States
(12) Patent Application Publication
(10) Pub. No.: US 2026/0185249 A1
(43) Pub. Date: Jul. 2, 2026

(54) MOF-DERIVED NITROGEN-COBALT HETEROGENEOUS NANO-BOX ELECTROCATALYST, PREPARATION METHOD AND APPLICATION

(71) Applicant: Anhui University of Science & Technology, Huainan City (CN)

(72) Inventors: JINSONG HU, Huainan City (CN); YUE LIU, Huainan City (CN); XU CHEN, Huainan City (CN); JIE LEI, Huainan City (CN)

(73) Assignee: Anhui University of Science & Technology, Huainan City, AN (CN)

(21) Appl. No.: 18/854,065

(22) PCT Filed: Mar. 25, 2024
(86) PCT No.: PCT/CN2024/083560

§ 371 Date: Oct. 4, 2024

(30) Foreign Application Priority Data
May 16, 2023 (CN) 2023105494596

(51) Int. Cl. C25B 11/095; C25B 1/04

(52) U.S. Cl. CPC C25B 11/095; C25B 1/04

(57) ABSTRACT

A MOF-derived nitrogen-cobalt heterogeneous nano-box electrocatalyst, along with its preparation method and application, is disclosed. The preparation involves the following steps: S1: preparing a ZIF-67 template; S2: dissolving the ZIF-67 template in anhydrous methanol through ultrasonic stirring to form solution A; S3: dissolving 1H-1,2,3-triazole in anhydrous methanol to form solution B; S4: combining solutions A and B, stirring, allowing the mixture to stand, and performing a substitution reaction; S5: centrifuging, drying, and carbonizing the product under nitrogen protection to obtain the electrocatalyst. In this method, 2-methylimidazole in the ZIF-67 framework is partially replaced by a high-energy nitrogen-containing ligand, 1H-1,2,3-triazole, which provides an abundant nitrogen source and locally restricts cobalt atom coordination. As a result, the electrocatalyst exhibits low hydrogen evolution overpotential under alkaline conditions (1 mol/L KOH).

### TECHNICAL FIELD

The present invention relates to the technical field of catalysts, in particular to an MOF-derived nitrogen-cobalt heterogeneous nano-box electrocatalyst, a preparation method and application.

### BACKGROUND ART

With rapid development of the human society, a large number of fossil fuels such as petroleum, natural gas, coal, and the like are consumed for industrial upgrading, resulting in deterioration of air environment and the increasing depletion of energy resources. Therefore, the demand for clean energy is increasing day by day, and it is urgent to find alternative clean energy. In order to protect the environment and reduce the use of fossil fuels, researchers focus on exploring and developing more sustainable and renewable technologies to collect, convert and store the energy. At present, the human beings have made great progress in the research of new energy fields such as wind energy, solar energy, hydropower and tidal energy. Particularly, the electrochemical hydrogen production technology has maintained a high increasing rate in recent years, and is considered as a clean and sustainable green energy utilization mode; and hydrogen has attracted much attention as an energy conversion and storage medium. Therefore, under the above background, designing and developing recyclable and environment-friendly non-noble metal catalysts with low cost, excellent stability and low overpotential of electrocatalytic hydrogen evolution is a hot research topic at present.

The traditional noble metal electrocatalysts for hydrogen evolution reaction, such as platinum and ruthenium catalysts, are not suitable for long-term use because of single catalytic activity and poor stability, although the overpotential required for hydrogen evolution reaction is low. Moreover, the preparation process is complicated, and some preparation conditions require high temperature and high pressure environment, which consumes a lot of energy. On the other hand, the noble metal electrocatalyst is highly susceptible to poisoning during use, which leads to low utilization efficiency of metal sites, and affects the catalytic performance of the catalyst, thereby increasing the consumption of the noble metals. Developing a non-noble metal electrocatalyst with good catalytic stability is a technical problem to be urgently solved in the art. Therefore, the present invention well overcomes the energy consumption, and utilizes non-noble metal cobalt as a metal source, and the synthesized electrocatalyst has good stability in a process of electrocatalytic water decomposition and hydrogen evolution, and has promising practical application prospect.

### SUMMARY OF THE INVENTION

Based on the technical problems in the background art, the present invention provides an MOF-derived nitrogen-cobalt heterogeneous nano-box electrocatalyst, a preparation method and application; and 2-methylimidazol in an imidazole zeolite skeleton ZIF-67 is partially substituted by a high-energy nitrogen-containing ligand, i.e. 1H-1,2,3-triazole ligand to provide abundant nitrogen source and locally restrict a cobalt atom coordination environment, so that the prepared electrocatalyst has relatively low hydrogen evolution overpotential.

According to the MOF-derived nitrogen-cobalt heterogeneous nano-box electrocatalyst provided by the present invention, the catalyst is formed by partially substituting the zeolite imidazole skeleton with the ligand and pyrolyzing into a nitrogen-rich cobalt heterogeneous nano cubic porous composite material with multiple Co/CoN heterogeneous catalytic centers.

A preparation method of the MOF-derived nitrogen-cobalt heterogeneous nano-box electrocatalyst provided by the present invention includes the following steps:
S1: preparing a ZIF-67 template;
S2: mixing a methanol solution of 1H-1,2,3-triazole and a methanol solution of ZIF-67 template of S1 for reaction; and
S3: centrifuging and drying a product after the reaction, and carbonizing the product under the protection of nitrogen to form the MOF-derived nitrogen-cobalt heterogeneous nano-box electrocatalyst.

Preferably, a method for preparing the ZIF-67 template includes the following steps:
S11: dissolving 2-methylimidazol in deionized water; and
S12: dissolving cobaltous nitrate hexahydrate and cetylammonium bromide in deionized water, then adding into the solution of S11 for reaction, centrifuging, washing and drying after reaction to form the ZIF-67 template.

Preferably, a mass ratio of 2-methylimidazol to cobaltous nitrate hexahydrate to cetylammonium bromide is 1:(0.06-0.08):(0.001-0.0015).

Preferably, reaction conditions in S12 are as follows: the reaction temperature is 20-25° C., first stirring lasts for 20-40 min, and then standing lasts for 1-2 h.

Preferably, centrifugal conditions in S12 are as follows: a rotation speed is 8000-9500 r/min, and the time is 5-7 min.

Preferably, drying conditions in S12 are as follows: the temperature is 50-70° C., and the time is 8-24 h.

Preferably, the centrifugal conditions in S12 are as follows: the rotation speed is 8000-9500 r/min, and the time is 5-7 min; and drying conditions are as follows: the temperature is 50-70° C., and the time is 8-24 h.

Preferably, a mass ratio of the ZIF-67 template to 1H-1,2,3-triazole is 1:(0.5-1.5).

Preferably, reaction conditions in S2 are as follows: the temperature is 30-35° C., and the time is 15-25 min.

Preferably, centrifugal conditions in S3 are as follows: a rotation speed is 8000-9500 r/min, and the time is 5-7 min.

Preferably, drying conditions in S3 are as follows: the temperature is 50-70° C., and the time is 8-24 h.

Preferably, carbonization conditions in S3 are as follows: the temperature is 400-600° C., the time is 1-3 h, and a heating rate is 3-5° C./min.

The present invention provides application of the MOF-derived nitrogen-cobalt heterogeneous nano-box electrocatalyst in electrocatalytic water decomposition for hydrogen production.

### Action Mechanism

According to the present invention, a nitrogen-rich organic ligand exchange strategy is adopted, the nitrogen-rich organic ligand is used for local restriction, and then a cobalt-containing compound is converted into a cobalt heterogeneous electrocatalytic nano-box with rich active sites of Co/CoN heterogeneous particles and a porous structure through high-temperature pyrolysis in a nitrogen atmosphere. The composite material prepared by the method is in a shape of hollow cube, and has high specific surface area and rich Co/CoN heterogeneous active sites, which is used for optimizing kinetics of hydrogen evolution reaction in electrocatalysis and gas-liquid mass transfer rate.

### Beneficial Effects:

(1) According to the present invention, 2-methylimidazol in an imidazole zeolite skeleton ZIF-67 is partially substituted by high-energy nitrogen-containing ligand, i.e. 1H-1,2,3-triazole ligand to provide abundant nitrogen source and locally restrict a cobalt atom coordination environment, and then pyrolyzed to form the cobalt heterogeneous porous composite nano-box with multiple Co/CoN heterogeneous catalytic centers. Due to the instability of nitrogen-nitrogen double bond in the pyrolysis process, 1H-1,2,3-triazole high-energy nitrogen-containing ligand is easily decomposed at high temperature to release energy instantaneously, so that the catalytic centers of the catalyst are locally regulated to produce a suitable porous structure and rich catalytic active sites; and moreover, the overall morphology remains good before and after the pyrolysis.

(2) The cobalt heterogeneous porous composite material rich in Co/CoN heterogeneous catalytic centers prepared by the present invention may be used as a hydrogen evolution catalyst to electrocatalyze the water decomposition to produce hydrogen, and has relatively low hydrogen evolution overpotential under an alkaline condition of 1 mol/L KOH aqueous solution.

(3) The porous structure and specific surface area of the catalyst prepared by the present invention are regulated and controlled by the substitution time of the nitrogen-rich organic ligand; and the preparation process is simple, easy to operate and reproduce, and convenient for industrialized production.

### BRIEF DESCRIPTION OF THE DRAWINGS

FIG. 1 shows a scanning electron microscope (SEM) image according to the present invention; FIG. 1(a): ZIF-67, before calcination, FIG. 1(b): ZIF-67, after calcination, FIG. 1(c): Co/CoN-20, before calcination, and FIG. 1(d): Co/CoN-20, after calcination;

FIG. 2(a) and FIG. 2(b) show transmission electron microscope (TEM) images of Co/CoN-20, FIG. 2(c) shows a high-resolution electron microscope (HRTEM) image of Co/CoN-20, and FIG. 2(d) shows a regional electron diffraction (SAED) image of Co/CoN-20;

FIG. 3(a) is a Fourier infrared (IR) diagram of comparison between Co/CoN-20 and ZIF-67; and FIG. 3(b) is an X-ray diffraction (XRD) diagram of comparison between Co/CoN-20 and ZIF-67.

FIG. 4(a) is an X-ray photoelectron energy spectrum (XPS) diagram of nitrogen species of Co/CoN-20, and FIG. 4(b) is a comparison diagram of content distribution of different nitrogen species of Co/Co-20 and ZIF-67-NC.

FIG. 5(a) shows a polarization curve, FIG. 5(b) a Tafel slope, FIG. 5(c) a constant current stability test curve and FIG. 5(d) an impedance curve of hydrogen evolution of Co/CoN-20 in 1 mol/L KOH aqueous solution.

FIG. 6 (a) shows a schematic diagram of hydrogen production by electrolysis of water, FIG. 6(b) a water decomposition curve, FIG. 6(c) a water decomposition stability test curve and FIG. 6(d) a scanning electron microscope (SEM) image of Co/CoN-20 after water decomposition stability test.

### DETAILED DESCRIPTION OF THE EMBODIMENTS

The present invention is further described in detail below in combination with embodiments.

In the embodiments of the present invention, nitric acid hexahydrate, 1H-1,2,3-triazole and 2-methylimidazole were purchased from Shanghai Macklin Biochemical Co., Ltd.; potassium hydroxide was purchased from Sinopharm Chemical Reagent Co., Ltd.; anhydrous methanol was purchased from Jiangsu Chinasun Specialty Products Co., Ltd.; and all the above raw materials are analytically pure.

An ultrasonic cleaning machine in a test apparatus used in the present invention was purchased from Kunshan Ultrasonic Instrument Co., Ltd.; a scanning electron microscope (SEM, FlexSEM1000) was purchased from Hitachi in Japan; a transmission electron microscope (TEM, JEM2100F) was purchased from Japan Electronics; a Fourier infrared spectrometer (FT-IR, Nicolet is50) was purchased from Thermo Fisher Scientific Inc. in USA; an X-ray photoelectron spectrometer (XPS, 250xi) was purchased from Thermo Fisher Scientific Inc.; an X-ray diffractometer (XRD, Smartlab SE) was purchased from RIGAKU in Japan; and an electrochemical workstation was purchased from Shanghai CH Instruments Co., Ltd.

### EXAMPLE 1

The present invention provides a preparation method of an MOF-derived nitrogen-cobalt heterogeneous nano-box electrocatalyst, which includes the following steps:
S1: 4.54 g of 2-methylimidazol was measured and placed in a beaker, then 70 mL of deionized water was measured and placed in the beaker, and ultrasonically dissolved to form a homogeneous clear solution;
S2: 0.29 g of Co(NO₃)₂·6H₂O and 5 mg of cetylammonium bromide were measured and placed in a beaker, then 10 mL of deionized water was measured and placed in the beaker, and ultrasonically dissolved to form a homogeneous clear solution;
S3: the solution of S2 was dripped into the solution of S1 at room temperature, the solution of S1 was continuously stirred for 30 min while dripping to uniformly mix the material, and then the mixture was stood for 2 h;
S4: a product formed after the standing in S3 was centrifuged for 5 min at 8500 r/min, a solid material obtained after the centrifuging was dried for 24 h at 50° C., and a dried sample was written as ZIF-67; and
S5: the dried material in S4 was heated to 500° C. at a rate of 5° C./min, and calcinated and carbonized for 2 h to form a composite material ZIF-67-NC.

### EXAMPLE 2

The present invention provides a preparation method of an MOF-derived nitrogen-cobalt heterogeneous nano-box electrocatalyst, which includes the following steps:
S1: 500 mg of ZIF-67 template was measured and placed in a beaker, then 50 mL of anhydrous methanol solution was measured and placed in the beaker, and ultrasonically stirred uniformly to form a purple solution;
S2: 600 μL of 1H-1,2,3-triazole was measured and placed in a beaker, then 50 mL of anhydrous methanol solution was measured and placed in the beaker, and ultrasonically stirred to form a homogeneous clear solution;
S3: the solution of S2 was dripped into the solution of S2 at room temperature, the solution was stirred while dripping, the mixture was stirred for 3 min after the solution was completely added to uniformly mix the material, and by controlling the reaction temperature at 30° C., the mixture was stood for 20 min;
S4: a product formed after the mixture was stood in S3 was centrifuged for 3 min at 8000 r/min, and a solid material obtained after the centrifuging was dried for 12 h at 50° C.; and
S5: the dried material in S4 was heated to 500° C. at a rate of 5° C./min, and calcinated and carbonized for 2 h to form a composite material Co/CoN-NC-20.

### EXAMPLE 3

The present invention provides a preparation method of an MOF-derived nitrogen-cobalt heterogeneous nano-box electrocatalyst, which includes the following steps:
S1: 500 mg of ZIF-67 template was measured and placed in a beaker, then 50 mL of anhydrous methanol solution was measured and placed in the beaker, and ultrasonically stirred uniformly to form a purple solution;
S2: 600 μL of 1H-1,2,3-triazole was measured and placed in a beaker, then 50 mL of anhydrous methanol solution was measured and placed in the beaker, and ultrasonically stirred to form a homogeneous clear solution;
S3: the solution of S2 was dripped into the solution of S2 at room temperature, the solution was stirred while dripping, the mixture was stirred for 3 min after the solution was completely added to uniformly mix the material, and the mixture was stood for 40 min by controlling the reaction temperature at 30° C.;
S4: a product formed after the mixture was stood in S3 was centrifuged for 3 min at 8000 r/min, and a solid material obtained after the centrifuging was dried for 12 h at 50° C.; and
S5: the dried material in S4 was heated to 500° C. at a rate of 5° C./min, and calcinated and carbonized for 2 h to form a composite material Co/CoN-NC-40.

### EXAMPLE 4

The present invention provides a preparation method of an MOF-derived nitrogen-cobalt heterogeneous nano-box electrocatalyst, which includes the following steps:
S1: 500 mg of ZIF-67 template was measured and placed in a beaker, then 50 mL of anhydrous methanol solution was measured and placed in the beaker, and ultrasonically stirred uniformly to form a purple solution;
S2: 600 μL of 1H-1,2,3-triazole was measured and placed in a beaker, then 50 mL of anhydrous methanol solution was measured and placed in the beaker, and ultrasonically stirred to form a homogeneous clear solution;
S3: the solution of S2 was dripped into the solution of S1 at room temperature, the solution was stirred while dripping, the mixture was stirred for 3 min after the solution was completely added to uniformly mix the material, and by controlling the reaction temperature at 30° C., the mixture was stood for 90 min;
S4: a product formed after the mixture was stood in S3 was centrifuged for 3 min at 8000 r/min, and a solid material obtained after the centrifuging was dried for 12 h at 50° C.; and
S5: the dried material in S4 was heated to 500° C. at a rate of 5° C./min, and calcinated and carbonized for 2 h to form a composite material Co/CoN-NC-90.

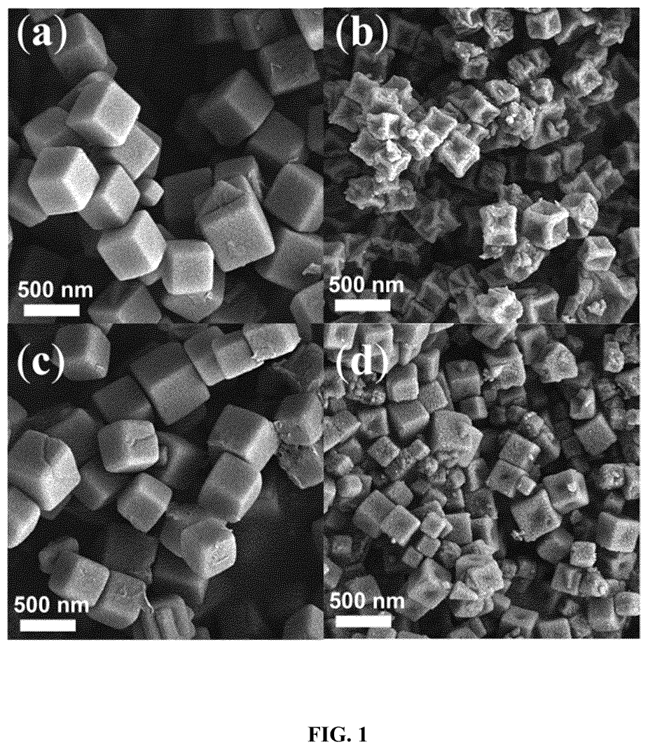

It can be seen from FIG. 1 that when 1H-1,2,3-triazole organic ligand is not added for substitution, the ZIF-67 template sample presents a cubic morphology and is small in size, as shown in FIG. 1(a); after high-temperature carbonization, it can be found that the surface shrinks, and each surface is recessed in the center, as shown in FIG. 1(b); when 1H-1,2,3-triazole organic ligand is added for substitution, the sample presents a similar cubic morphology with small change in size, as shown in FIG. 1(c); and furthermore, after high-temperature carbonization, it can be found that the cubic shape of the sample is not destroyed, and the surface shrinkage is weaker than that before the substitution, but the surface becomes rougher, as shown in FIG. 1(d).

Furthermore, electrochemical properties of the sample were represented by a three-electrode system on a CHI760D electrochemical workstation. 1.5 mg of sample obtained in the experiments was measured, 15 μL of polyvinylidene fluoride (PVDF) solution (15 wt %) was added as a conductive adhesive, and the conductive adhesive is prepared with N-methylpyrrolidone (NMP) as a solution. The sample and the polyvinylidene fluoride (PVDF) were collectively added into the N-methylpyrrolidone (NMP) solution, and ultrasonically stirred for 30 min to dissolve the PVDF in the NMP, and the sample material was completely dispersed in the solution. Next, prepared suspension liquid was dripped on a prepared graphite sheet (1 cm×1 cm) by using a pipette, with a loading amount of 0.5 mg/cm². Then, the electrode with the sample was placed in a drying oven at 80° C. and dried for 2 H to prepare a working electrode. The working electrode in the three-electrode system is the graphite sheet (1 cm×1 cm) loaded with the test sample, a graphite electrode is used as a counter electrode, and a mercury/mercuric oxide (Hg/HgO) electrode was used as a reference electrode. 1 mol/L potassium hydroxide solution (pH=13.8) was used as electrolyte. The potentials used herein are all converted into values corresponding to a reversible hydrogen electrode (RHE) by a formula E_{RHE}=E_{Hg/HgO}+0.098+0.0591 * pH derived from Nernst equation, where E_{Hg/HgO} in the formula is the potential applied to the reference electrode Hg/HgO electrode. The hydrogen evolution property of the catalyst material was tested by linear sweep voltammetry (LSV), and the long-term stability of the catalyst material was tested by Chrono Potentiometry (CP).

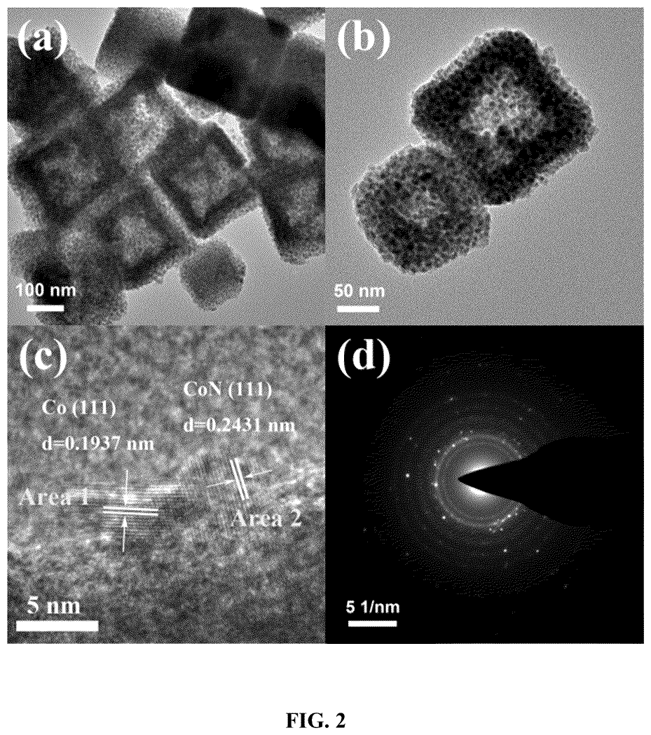

For the ZIF-67 carbonized sample partially substituted by organic ligand, the morphology and composition of the product were further discussed with a transmission electron microscope (TEM). The TEM image shows that the pyrolyzed sample Co/CoN-NC-20 still maintains the original cubic shape after heat treatment. It can be seen that the surface is full of cluster particles, and the inside is hollow, which is attributed to the pyrolysis of 1H-1,2,3-triazole, where 1H-1,2,3-triazole is a high-energy ligand, which is decomposed rapidly to release heat, resulting in the lack of carbon isolation between metal ions, so that nitrogen-rich clusters and cavities are easier to form, as shown in FIG. 2(a) and 2(b). In a high-resolution transmission electron microscope (HRTEM) image, it can be seen that there are crystal planes of element cobalt (Co)(111) and cobalt nitride (CoN)(111) in nitrogen-rich clusters of Co/CoN-NC-20, with inter-planar distances respectively of 0.1937 nm and 0.2431 nm, and a Co/CoN heterogeneous structure is formed at the junction of two crystal planes, as shown in FIG. 2(c). Obvious diffraction rings can be seen in a selected regional electron diffraction (SAED) image, which further proves that element cobalt (Co) and cobalt nitride (CoN) species are formed in the material after carbonization, the same as the result in a HETEM image, as shown in FIG. 2(d). Nitrogen-rich components of the MOF-derived cubic nitrogen-rich material are clustered in the high-temperature heat treatment process to prepare the cobalt heterogeneous nano catalyst with abundant Co/CoN heterogeneous active sites.

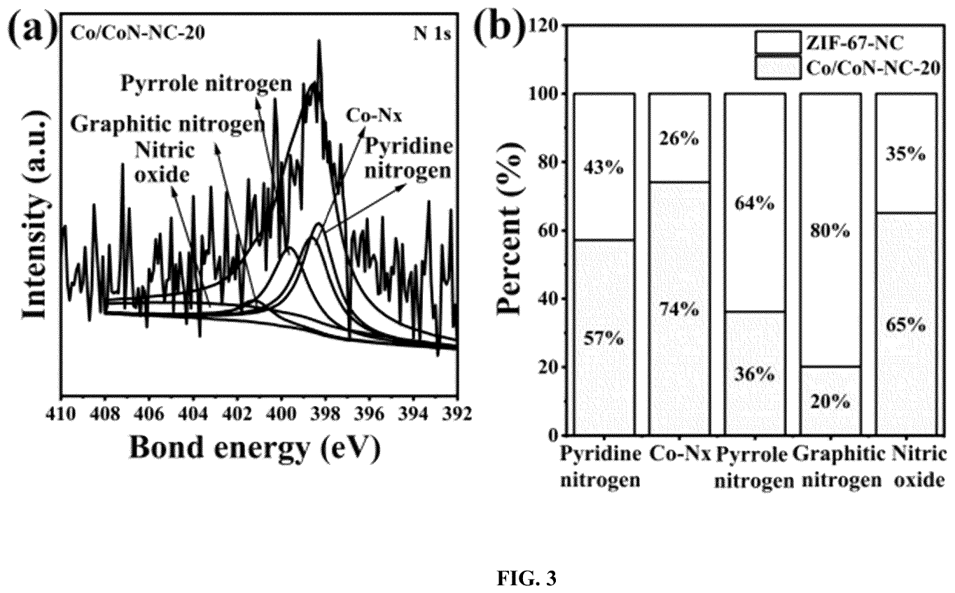

It can be seen from the X-ray photoelectron energy spectrum (XPS) that the content of Co-Nx in Co/CoN-NC-20 reaches 74%, which is far greater than the content (26%) of the Co-Nx in the ZIF-67 template before the substitution with the nitrogen-rich ligand, as shown in FIG. 3(a) and 3(b). Furthermore, Co-Nx is very important for the formation of active Co/CoN heterogeneous catalytic active sites and the liquid adsorption and gas precipitation on the surface of material, which is beneficial to enhance the conductivity and gas-liquid diffusion transmission rate of the electrocatalyst.

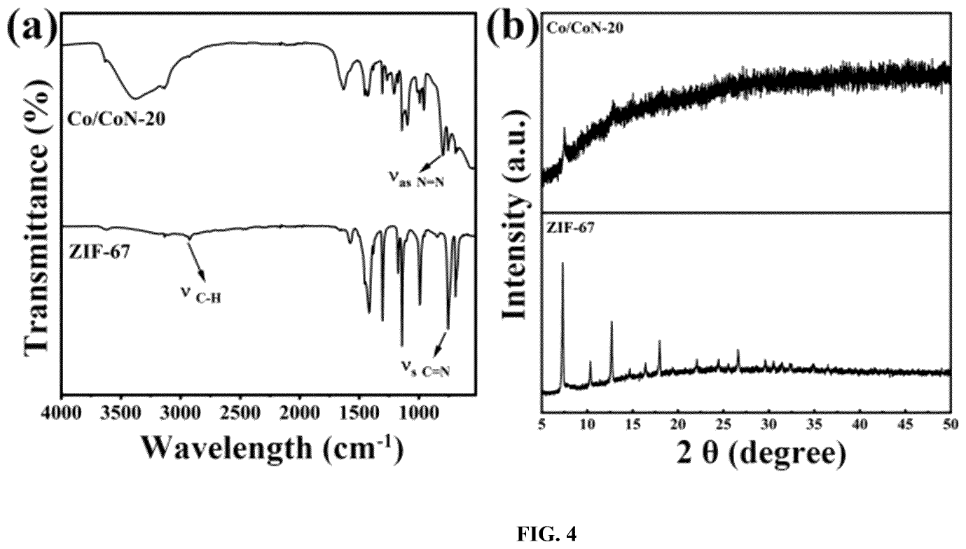

It can be seen from Fourier transform infrared spectroscopy (FT-IR) and X-ray diffraction spectroscopy (XRD) that the 2-methylimidazole ligand in the ZIF-67 template is partially substituted by 1H-1,2,3-triazole successfully. It can be seen from the infrared spectrum that peaks at 750 cm⁻² and 797 cm⁻² belong to a tensile vibration peak of C═N double bond in a 2-methylimidazole molecule and an anti-symmetric tensile vibration peak of N═N in a 1H-1,2,3-triazole molecule respectively, and the peak at 2915cm⁻² belongs to the tensile vibration peak of methyl C—H in a dimethyl imidazole molecule, which proves that some 1H-1,2,3-triazole and cobalt salt are coordinated in Co/CoN-20, as shown in FIG. 4a. In the X-ray diffraction spectrum, after the partial substitution of 1H-1,2,3-triazole organic ligand for 20 min, a characteristic peak belonging to ZIF-67 is weakened, which may be due to the fact that the substitution of 2-methylimidazole ligand in ZIF-67 by 1H-1,2,3-triazole leads to the destruction of periodicity of coordination between cobalt salt and 2-methylimidazole in ZIF-67 and the decrease of crystallinity, as shown in FIG. 4b.

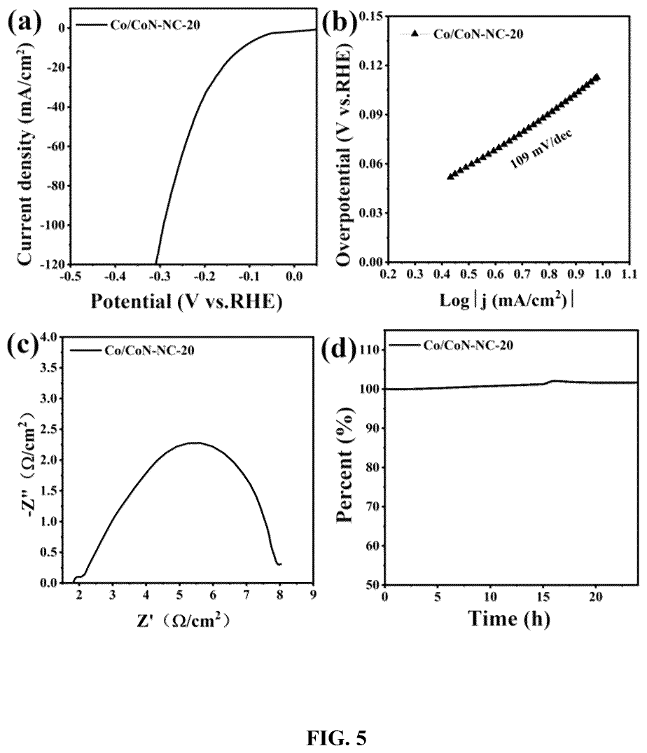

HER properties of the product are as follows: HER activity of Co/CoN-NC-20 electrocatalyst in 1 mol/L KOH solution was studied by using the Chenhua Electrochemical workstation. Results of linear sweep voltammetry (LSV) show that the potential (η) required for Co/CoN-NC-20 to reach the current density of 10 mA/cm² is only 115 mV, as shown in FIG. 5(a), which is better than the HER properties of the majority of non-noble metals; as shown in FIG. 5(b), a Tafel slope of the Co/CoN-NC-20 electrocatalyst is 109 mV·dec⁻¹, and the smaller the Tafel slope, the more beneficial to the kinetic process of hydrogen evolution reaction (HER); and as shown in FIG. 5(c), the impedance spectrum reveals the kinetics of electrocatalytic reaction, the smaller the impedance radius, the higher the electron transfer rate, and the smaller the impedance radius of Co/CoN-NC-20, the faster the kinetics of electrocatalytic reaction. In addition, as shown in FIG. 5(d), the long-term stability of the catalyst in an application process is evaluated by continuously inputting current density of 10 mA/cm², and detecting the voltage change with time, and in the diagram, Co/CoN-NC-20 presents strong durability; after 24-hour constant-current test, the voltage is only slightly increased by 1.65% compared with the initial voltage, which proves that the catalyst has excellent HER stability.

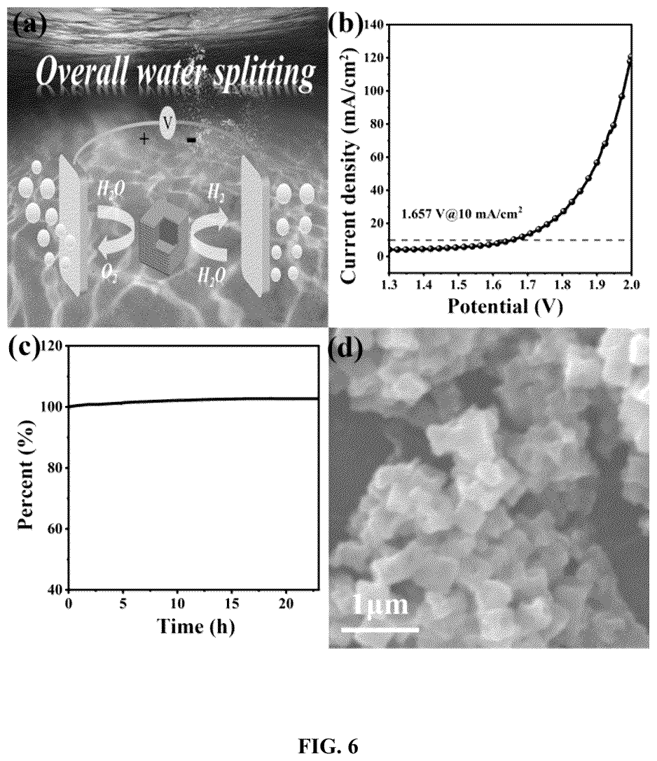

Furthermore, the electrocatalytic decomposition of water and electrocatalytic water decomposition stability of the Co/CoN-NC-20 catalyst were further tested. As shown in FIG. 6(b), when the current density for water decomposition reaches 10 mA/cm², the needed voltage is only 1.657 V. As shown in FIG. 6(c), after water electrolysis with a current density of 10 mA/cm² is kept for 24 hours, the voltage can still maintain good stability and is only increased by 2.16%, which proves that Co/CoN-NC-20 has good electrocatalytic stability in practical hydrogen production by water electrolysis and has realistic application prospect. It can be seen from FIG. 6(d) that after 24-hour constant current water decomposition stability test, the material has no obvious change in morphology, and still maintains cubic morphology, which further proves the structural stability.

What is claimed is:

1. An MOF-derived nitrogen-cobalt heterogeneous nano-box electrocatalyst, wherein the catalyst takes zeolite imidazole as a matrix, which is partially substituted by ligands and pyrolyzed into a cubic porous composite material with multiple Co/CoN heterogeneous catalytic centers.

2. A preparation method of the MOF-derived nitrogen-cobalt heterogeneous nano-box electrocatalyst according to claim 1, comprising the following steps:
S1: preparing a ZIF-67 template;
S2: mixing a methanol solution of 1H-1,2,3-triazole and a methanol solution of ZIF-67 template of S1 for reaction; and
S3: centrifuging and drying a product after the reaction, and carbonizing the product under the protection of nitrogen to form the MOF-derived nitrogen-cobalt heterogeneous nano-box electrocatalyst.

3. The preparation method of the MOF-derived nitrogen-cobalt heterogeneous nano-box electrocatalyst according to claim 2, wherein a method for preparing the ZIF-67 template comprises the following steps:
S11: dissolving 2-methylimidazol in deionized water; and
S12: dissolving cobaltous nitrate hexahydrate and cetylammonium bromide in deionized water, then adding into the solution of S11 for reaction, centrifuging, washing and drying after reaction to form the ZIF-67 template.

4. The preparation method of the MOF-derived nitrogen-cobalt heterogeneous nano-box electrocatalyst according to claim 3, wherein a mass ratio of 2-methylimidazol to cobaltous nitrate hexahydrate to cetylammonium bromide is 1:(0.06-0.08):(0.001-0.0015).

5. The preparation method of the MOF-derived nitrogen-cobalt heterogeneous nano-box electrocatalyst according to claim 3, wherein reaction conditions in S12 are as follows: the reaction temperature is 20-25° C., first stirring lasts for 20-40 min, and then standing lasts for 1-2 h; centrifugal conditions in S12 are as follows: a rotation speed is 8000-9500 r/min, and the time is 5-7 min; and drying conditions are as follows: the temperature is 50-70° C., and the time is 8-24 h.

6. The preparation method of the MOF-derived nitrogen-cobalt heterogeneous nano-box electrocatalyst according to claim 2, wherein a mass ratio of the ZIF-67 template to 1H-1,2,3-triazole is 1:(0.5-1.5).

7. The preparation method of the MOF-derived nitrogen-cobalt heterogeneous nano-box electrocatalyst according to claim 2, wherein reaction conditions in S2 are as follows: the temperature is 30-35° C., and the time is 15-25 min.

8. The preparation method of the MOF-derived nitrogen-cobalt heterogeneous nano-box electrocatalyst according to claim 2, wherein centrifugal conditions in S3 are as follows: the rotation speed is 8000-9500 r/min, and the time is 5-7 min; and drying conditions are as follows: the temperature is 50-70° C., and the time is 8-24 h.

9. The preparation method of the MOF-derived nitrogen-cobalt heterogeneous nano-box electrocatalyst according to claim 2, wherein carbonization conditions in S3 are as follows: the temperature is 400-600° C., the time is 1-3 h, and a heating rate is 3-5° C./min.

10. Application of the MOF-derived nitrogen-cobalt heterogeneous nano-box electrocatalyst according to claim 1 in electrocatalytic water decomposition for hydrogen production.
